(19) United States
(12) Patent Application Publication
(10) Pub. No.: US 2014/0188334 A1
(43) Pub. Date: Jul. 3, 2014

(54) Automatic Wheel Chock System

(71) Applicant: Christopher R. Foster, Round Mountain, NV (US)

(72) Inventor: Christopher R. Foster, Round Mountain, NV (US)

(21) Appl. No.: 13/729,347

(22) Filed: Dec. 28, 2012

(51) Int. Cl. B60T 7/12; B60T 1/04

(52) U.S. Cl. CPC B60T 7/12; B60T 1/04
USPC 701/36; 188/5

(57) ABSTRACT

A wheel chock system includes a hydraulic assembly coupled to a vehicle. Adjustment arms are mounted adjacent each tire, each adjustment arm having a proximal end operatively coupled to the hydraulic assembly and a distal end adjacent a road-encountering surface of a respective tire, the pair of adjustment arms being movable between deployed released configurations upon operation of the hydraulic assembly. A pair of chocks is coupled to respective second ends of the adjustment arms, the chocks being situated in contact with a respective vehicle tire at the deployed configuration and displaced from the respective vehicle tire at the extended configuration. An actuator is operatively coupled to the hydraulic assembly and configured to actuate the adjustment arms to move between deployed and released configurations. Sensors cause automatic deployment of the chocks when the vehicle ignition is turned off, when the gear is parked, and when the driver leaves his seat.

### BACKGROUND OF THE INVENTION

This invention relates generally to wheel chocks and, more particularly, to an automatic wheel chock system for use with a vehicle which automatically deploys one or more wheel chocks when a vehicle engine is turned off, a driver exits the vehicle, or when a gear shift is in a parked configuration.

While all automobiles pose a degree of risk of unintentionally rolling either forward or backward, heavy vehicles such as pickup, utility, delivery, mail delivery, construction trucks and the like are particularly susceptible to unintended movement because of their relatively heavy weight and perhaps driver forgetfulness to set emergency or parking brakes. Unintended movement of trucks may lead to property damage and injury.

Wheel chocks have been utilized for many years and which may be wedged in front or behind the wheels of a vehicle so as to prevent unintended rolling of the vehicle. Although assumably effective for their intended purposes, the existing wheel chock devices and patent proposals are still less than completely effective in that they may not be consistently deployed correctly or may not be deployed consistently in every circumstance in which their use is necessary or beneficial. For example, wheel chocks should be deployed whenever a vehicle is switched off, whenever the gear shift is positioned in “park,” and whenever a driver exits the vehicle.

Therefore, it would be desirable to have a wheel chock system that automatically deploys wheel chocks in front and behind the wheels of a vehicle in each of the circumstances named above.

### SUMMARY OF THE INVENTION

A wheel chock system for use with a vehicle according to the present invention includes a hydraulic assembly coupled to the vehicle. A pair of adjustment arms are mounted adjacent each tire, each adjustment arm having a proximal end operatively coupled to the hydraulic assembly and a distal end adjacent a road-encountering surface of a respective tire, the pair of adjustment arms being movable between a deployed configuration and a released configuration upon operation of the hydraulic assembly. A pair of chocks is coupled to respective second ends of the adjustment arms, the respective chocks being situated in contact with a respective vehicle tire at the deployed configuration and displaced from the respective vehicle tire at the extended configuration. An actuator is operatively coupled to the hydraulic assembly configured to actuate the pair of adjustment arms to move between the deployed and released configuration. The system described herein will by compliant with OSHA regulations.

Therefore, a general object of this invention is to provide an automatic wheel chock system for a vehicle that automatically deploys wheel chocks in front and behind the tires of a vehicle when the vehicle is not in motion.

Another object of this invention is to provide an automatic wheel chock system, as aforesaid, that automatically deploys wheel chocks when the vehicle engine is deactivated.

Still another object of this invention is to provide an automatic wheel chock system, as aforesaid, that automatically deploys wheel chocks when the vehicle gear shifter is placed in a park position.

Yet another object of this invention is to provide an automatic wheel chock system, as aforesaid, that automatically deploys wheel chocks when a driver exits the vehicle if they have not already been deployed.

A further object of this invention is to provide an automatic wheel chock system, as aforesaid, that eliminates the need for a driver to remember to manually deploy the wheel chocks.

A still further object of this invention is to provide an automatic wheel chock system, as aforesaid, that is easy to install and use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an automatic wheel chock system according to a preferred embodiment of the present invention in use on a vehicle and illustrated in a deployed configuration;

FIG. 2a is a front perspective view of the wheel chock system as in FIG. 1 illustrated in a released configuration;

FIG. 2b is a rear perspective view of the wheel chock system as in FIG. 2a;

FIG. 3 is an exploded view of the wheel chock system as in FIG. 1;

FIG. 4 is an enlarged view of a wheel chock taken from FIG. 3;

FIG. 5 is a perspective view of a driver's seat of a vehicle equipped with a load cell sensor according to the present invention;

FIG. 6 is a perspective view of a truck with a hydraulic assembly according to the present invention situated in the bed of the truck;

FIG. 7 is an exploded view of the hydraulic assembly; and

FIG. 8 is a block diagram of the electrical and electronic components of the present invention.

### DESCRIPTION OF THE PREFERRED EMBODIMENT

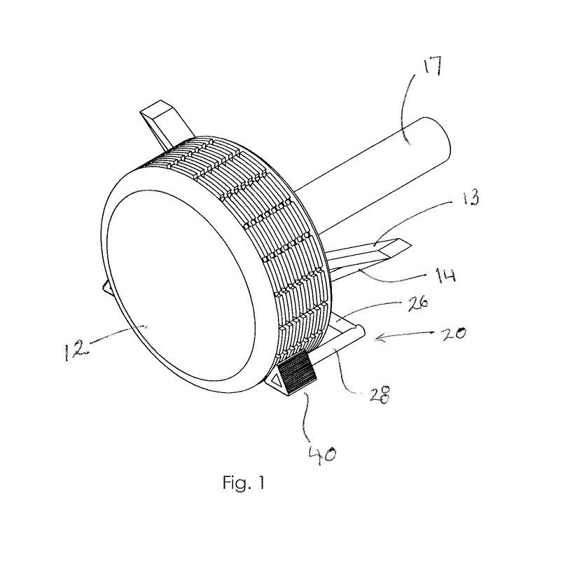

A wheel chock system for use with a vehicle according to a preferred embodiment of the present invention will now be described in detail with reference to FIGS. 1 to 8 of the accompanying drawings. The wheel chock system 10 includes a hydraulic assembly 30, at least a pair of adjustment arms 20, at least a pair of wheel chocks 40, an actuator 60, and specifically placed sensors 54, 56, 58 that cause the wheel chocks 40 to be automatically deployed.

The wheel chock system 10 is for use with a vehicle 11 of a type having an engine ignition switch for actuating the start of an engine, a transmission for changing gears, at least a driver's seat 15 in an occupant cabin, at least a pair of spaced apart tires 12 connected by an axle, and a pair of leaf springs coupled to the axle 17 adjacent respective tires. Preferably, the vehicle 11 described herein is a pickup truck or other work truck having a bed area behind a cabin area.

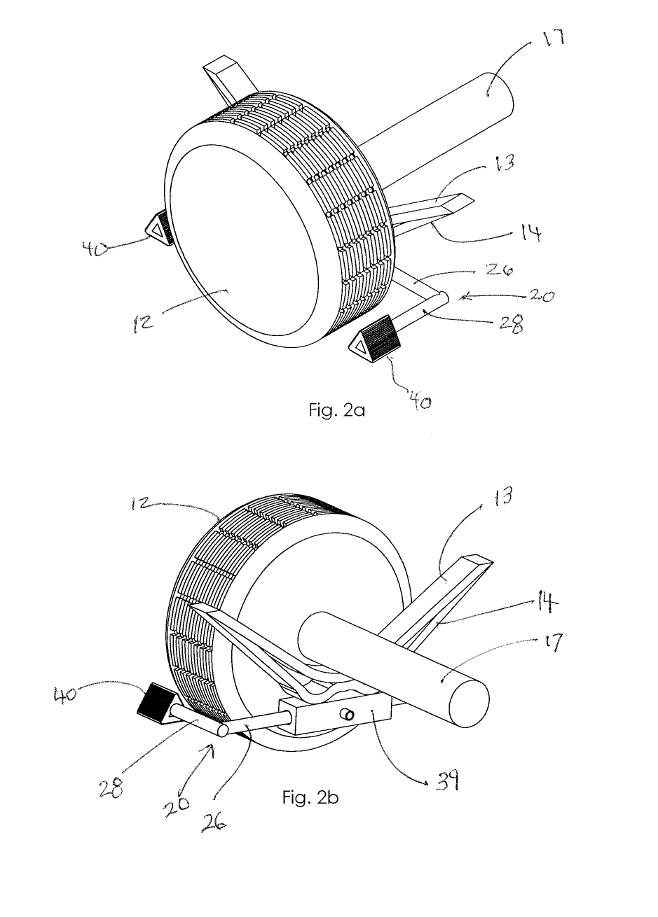

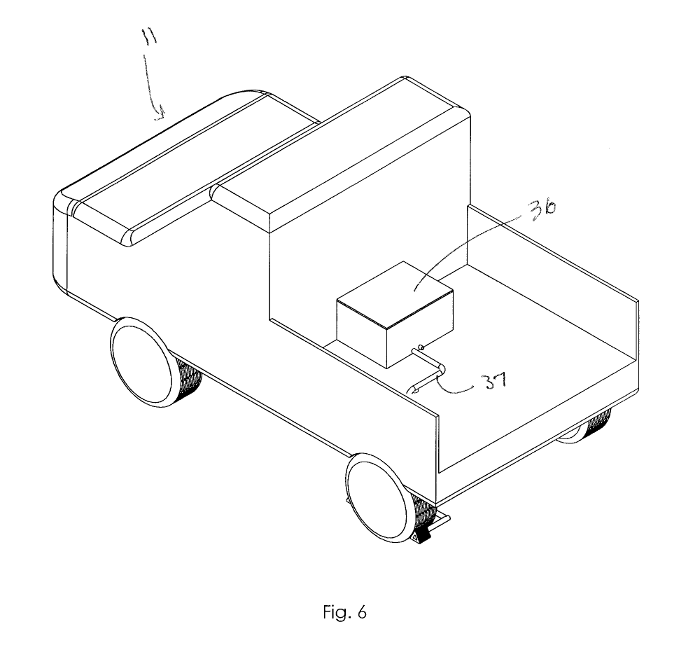

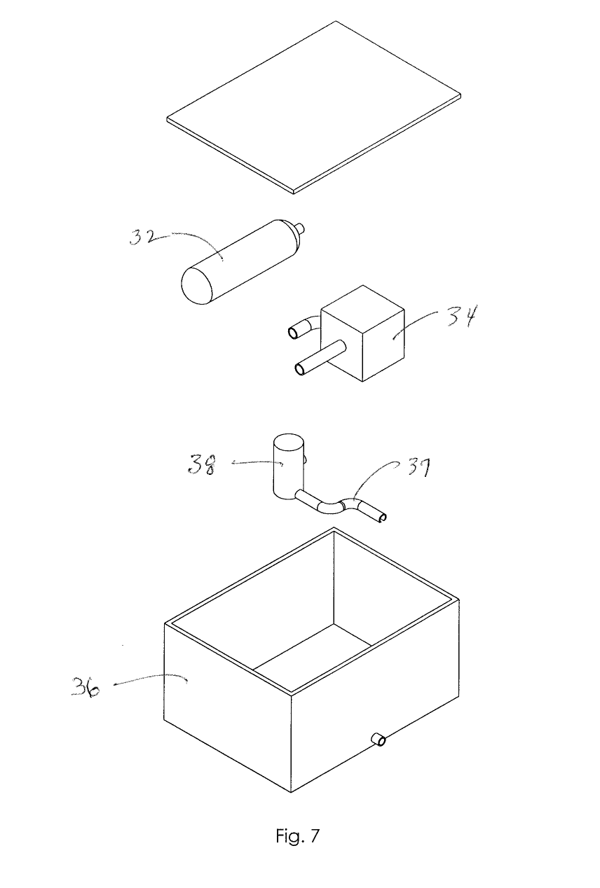

The hydraulic assembly 30 may include a reservoir 32 configured to contain a quantity of hydraulic fluid (FIG. 7). As shown in FIG. 1, the hydraulic reservoir 32 may be a canister. The hydraulic reservoir 32 and other components may be situated in a casing 36 configured to fit into the bed of a pickup, cargo, utility, or other industrial type truck (FIG. 6). The hydraulic assembly 30 may also include a hydraulic pump 34 in fluid communication with the hydraulic reservoir 32 for pumping hydraulic fluid to adjustment mechanisms as will be described below. A hydraulic fluid regulator 38 may also be included for managing fluid flow and pressure. The hydraulic assembly 30 may also include a ram housing 39 coupled to each leaf spring 13 of the vehicle 11. The ram housing 39 may be in fluid connection to the pump 34 with tubing 37 or hoses (FIG. 6). In some embodiments, an auxiliary leaf spring 14 may be coupled to the vehicle's leaf spring 13 such that the ram housing 39 is coupled to the auxiliary leaf spring 14 (FIG. 2b).

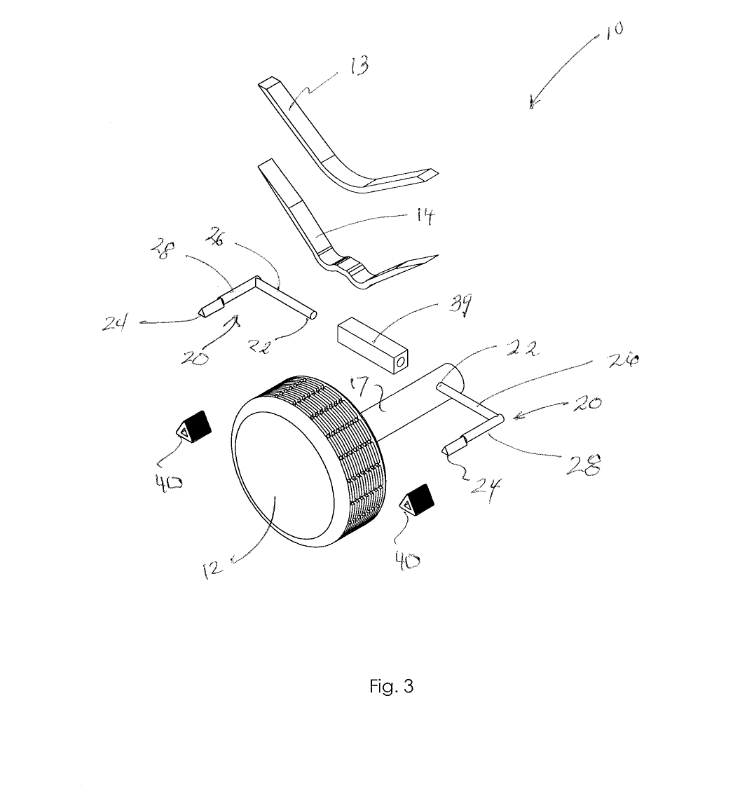

The adjustment arms 20 may be mounted adjacent each tire 12, each adjustment arm 20 including a proximal end 22 operatively connected to the hydraulic assembly 30 as will be described further below and a distal end 24 adjacent a respective tire 12. The proximal end 22 of each adjustment arm 20 may be received in the ram housing 39 of the hydraulic assembly 30 (FIG. 3). More particularly, an adjustment arm 20 may include a first portion 26 extending from a respective ram housing 39 and extending parallel to a respective tire 12.

The adjustment arm 20 may also include a second portion 28 coupled to an end of the first portion 26 away from the ram housing 39, the second portion 28 extending perpendicular to the first portion 26 so as to be positioned adjacent a road-encountering surface of a respective tire 12 (FIGS. 1 and 3). It can be seen that the first 26 and second 28 portions of each adjustment arm generally surround the tire.

It should be understood that an adjustment arm 20 may be coupled to forward and rearward ends of a ram housing 39 and thus be positioned relative to both the front and back surfaces of a respective tire. It is also understood that a ram housing 39 and a respective pair of adjustment arms 20 may be situated relative to both of the pair of wheels/tires on a vehicle although the present description and drawings are directed to a single tire and associated adjustment arms 20 for clarity.

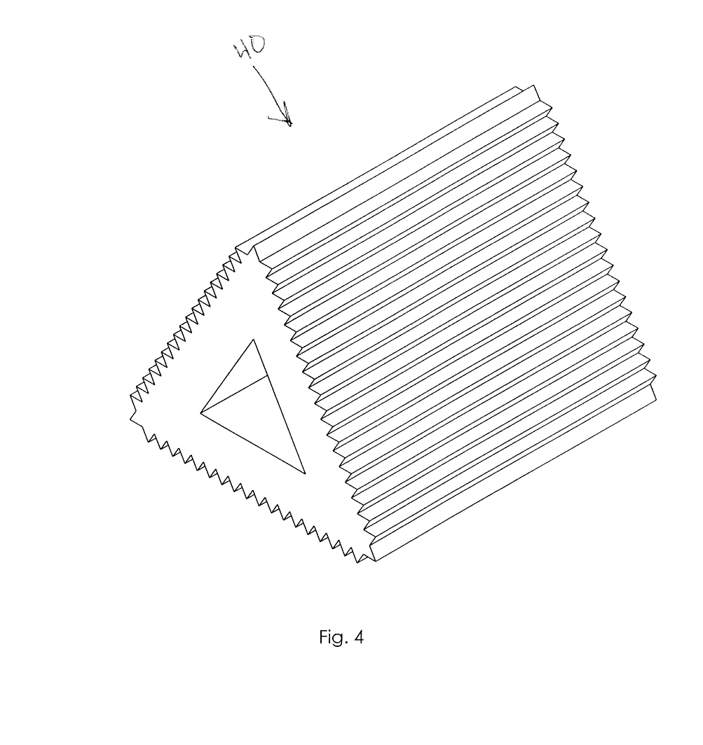

A wheel chock 40 is coupled to the distal end 24 of each adjustment arm 20. Each wheel chock 40 is configured to bear against the road-encountering surface of a respective tire when the adjustment arms 20 are at the deployed configuration. Each wheel chock 40 may include a generally triangular configuration (FIGS. 1 and 4). More particularly, the wheel chock 40 includes three sides, each side having a generally planar surface that may include a plurality of ridges or a texture over which a tire is inhibited from slippage. Each wheel chock 40 is rotatably coupled to a respective second end of a respective adjustment arm 20. In use, a wheel chock 40 may be rotated to position a selected side to bear against the tire 12. Routine rotation of the wheel chocks 40 enables the wheel chocks 40 to last longer; in other words, as one side becomes worn, a different side may be oriented to bear against a tire 12.

Each adjustment arm 20 is movable relative to the ram housing 39 between a deployed configuration at which a respective chock 40 bears against a tire surface (FIG. 1) and a released configuration at which a respective chock 40 is displaced from a tire surface (FIG. 2). Specifically, first portions 26 of a pair of adjustment arms 20 associated with a respective tire 12 are moved inwardly into an associated ram housing 39 when the adjustment arms 20 are deployed, causing respective wheel chocks 40 to engage against the tire 12 (FIG. 1). Conversely, first portions 26 of a pair of adjustment arms 20 associated with a respective tire 12 are moved outwardly from an associated ram housing 39 when the adjustment arms 20 are released, causing respective wheel chocks 40 to be displaced from the tire 12 (FIG. 2). The configuration of a hydraulic ram housing 39 is not new and is operable by changes in hydraulic pressure and spring mechanisms that cause rams (i.e. the adjustment arms) to extend and retract relative to the ram housing 39.

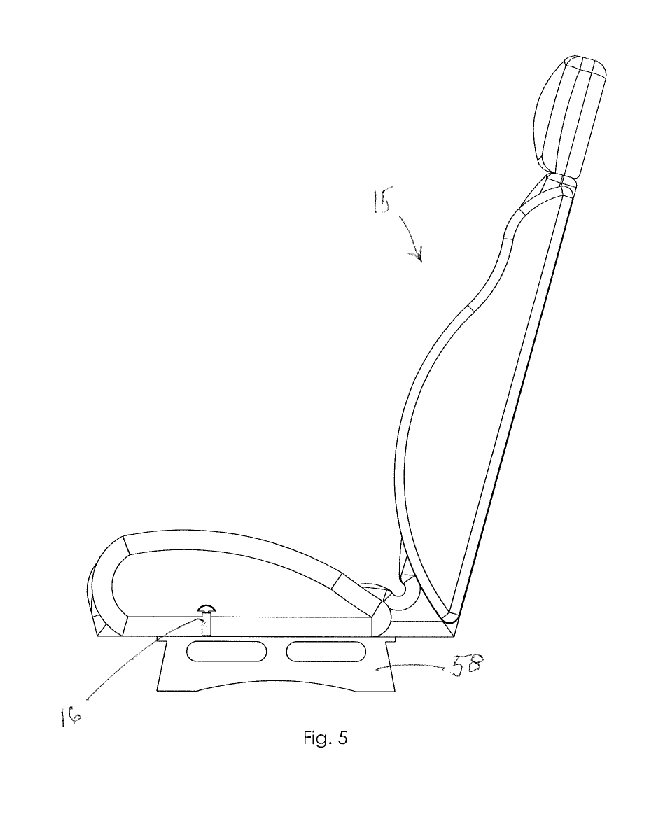

The wheel chock system 10 includes an actuator 60 operatively coupled to the hydraulic assembly 30 that is configured to actuate the pair of adjustment arms 20 to move between the deployed and released configurations. It is understood that the actuator 60 may be a button or switch 16 adjacent the driver's seat (FIG. 5) operable by a user to manually operate the adjustment arms or automatically by a processor 50 that initiates the hydraulic fluid to flow to a respective ram housing 39 and cause the adjustment arms 20 to either retract or extend.

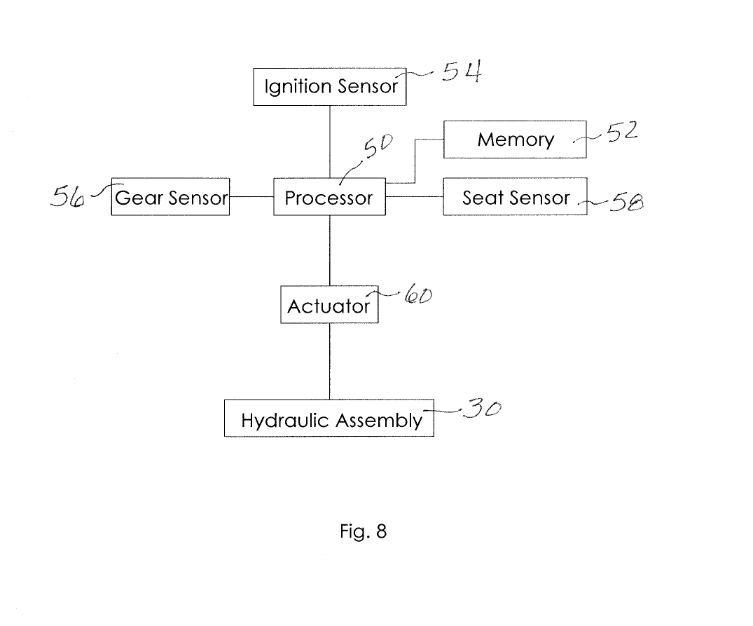

The wheel chock system 10 may include a memory 52 that stores programming instructions for operation of the actuator 60 to control hydraulic fluid flow (FIG. 8). The wheel chock system 10 may also include a processor 50 electrically connected to the memory 52 and configured to execute programming instructions stored in the memory 52. The processor 50 may cause the actuator to operate the hydraulic assembly 30 to move respective adjustment arms 20 between the deployed and released configurations.

The wheel chock system 10 includes an ignition sensor 54 electrically connected to the vehicle's ignition switch and to the processor 50. The ignition sensor 54 is configured to determine when the ignition switch is in an “off” configuration or, alternatively, to determined that the vehicle engine is not running. The processor 50, when executing programming instructions stored in memory 52, energizes the actuator 60 to operate the hydraulic assembly 30 to move respective adjustment arms 20 to the deployed configuration when the ignition switch is determined to be at the “off” configuration or that the engine is not running. In other words, the wheel chocks 40 are automatically moved to bear against the front and back of a vehicle tire when the vehicle has been turned off.

Further, the wheel chock system 10 includes a gear sensor 56 electrically connected to the vehicle's transmission and to the processor 50. Alternatively, the gear sensor 56 may be connected to a gear shift assembly. The gear sensor 56 is configured to determine when the transmission or gear assembly is at a “parked” configuration. The processor 50, when executing programming instructions stored in memory 52, energizes the actuator 60 to operate the hydraulic assembly 30 to move respective adjustment arms 20 to the deployed configuration when the gear sensor 56 determines that the transmission is in a “parked” configuration. In other words, the wheel chocks 40 are automatically moved to bear against the front and back of a vehicle tire when the vehicle transmission is parked as opposed to being in a driving gear.

Still further, the wheel chock system 10 includes a load cell sensor 58 electrically connected to the driver's seat 15 within the vehicle's occupant cabin and to the processor 50.

The load cell 58 is configured to determine when the seat is occupied or unoccupied. More particularly, the load cell 58 is configured to measure a weight in the seat and to determine if the measured weight is indicative of the presence of a person. The processor 50, when executing programming instructions stored in memory 52, energizes the actuator 60 to operate the hydraulic assembly 30 to move respective adjustment arms 20 to the deployed configuration when the load cell 58 is indicative of the driver's seat being unoccupied. An unoccupied seat, of course, indicates that the driver has exited the vehicle such that deployment of the wheel chocks would be desirable.

It is understood that some embodiments of the wheel chock system 10 may include some or all of the sensors described above. It is also understood that the wheel chock system 10 may include the button or switch 16 described above by which a driver may manually actuate the hydraulic assembly 30 to move the adjustment arms 20 to the deployed configuration.

In use, the wheel chock system 10 may be installed on a vehicle, such as by mounting the auxiliary leaf spring 14 and ram housing 39 to a leaf spring 13 of the vehicle 11 adjacent a tire 12 (FIG. 2b). It is understood that multiple ram housings 39, adjustment arms 20, and wheel chocks 40 may be installed and used with a vehicle 11 as described above. When one of the sensors 54, 56, 58 described above detects its respective condition, the processor 50 causes the actuator 60 to operate respective adjustment arms 20 by means of the hydraulic assembly 30 to move to the deployed configuration (FIG. 1) such that respective wheel chocks 40 bear against respective tires to prevent unintended movement thereof. When the sensor conditions are no longer detected, it is understood that the processor 50 may again cause the actuator 60 to operate respective adjustment arms 20 to move to the released configuration (FIG. 2).

Specifically, when the vehicle ignition switch is turned off, the wheel chocks 40 are automatically deployed. Likewise, when the vehicle 11 is shifted into park, the wheel chocks 40 are automatically deployed. In addition, when a driver exits the driver's seat such as to exits the vehicle, the wheel chocks 40 are automatically deployed. Accordingly, the system according to the present invention provides enhanced safety against unintended rolling of a vehicle.

It is understood that while certain forms of this invention have been illustrated and described, it is not limited thereto except insofar as such limitations are included in the following claims and allowable functional equivalents thereof.

1. A wheel chock system for a vehicle having an engine ignition switch, a transmission, and a driver's seat in vehicle occupant cabin, having at least of pair of spaced apart tires connected by an axle, and having a pair of leaf springs coupled to the axle adjacent respective tires, said wheel chock system, comprising:
a hydraulic assembly coupled to the vehicle;
a pair of adjustment arms mounted adjacent each tire, each adjustment arm having a proximal end operatively coupled to said hydraulic assembly and a distal end adjacent a road-encountering surface of a respective tire, said pair of adjustment arms being movable between a deployed configuration and a released configuration upon operation of said hydraulic assembly;
a pair of chocks coupled to respective second ends of said adjustment arms, said respective chocks being situated in contact with a respective vehicle tire at said deployed configuration and displaced from said respective vehicle tire at said extended configuration; and
an actuator operatively coupled to said hydraulic assembly configured to actuate said pair of adjustment arms to move between said deployed and said released configuration.

2. The wheel chock system as in claim 1, further comprising:
a memory having programming related to operation of said actuator; and
a processor in electrical communication with said memory and configured to execute respective programming to energize said actuator to operate said hydraulic assembly to move said pair of adjustment arms between said deployed and said released configurations.

3. The wheel chock system as in claim 2, further comprising:
an ignition sensor electrically connected to the vehicle ignition switch and to said processor, said ignition sensor detecting when the ignition switch is at an off configuration; and
programming in said memory that when executed by said processor causes said processor to energize said actuator to operate said hydraulic assembly to move said adjustment arms to said deployed configuration when the ignition switch is at the off configuration.

4. The wheel chock system as in claim 2, further comprising:
a gear sensor electrically connected to the vehicle transmission and to said processor, said gear sensor configured to determine when the vehicle transmission is in a parked configuration; and
programming in said memory that when executed by said processor causes said processor to energize said actuator to operate said hydraulic assembly to move said adjustment arms to said deployed configuration when said gear sensor determines that the vehicle transmission is in a parked configuration.

5. The wheel chock system as in claim 2, further comprising:
a load sensor in communication with the driver's seat and with said processor, said load sensor configured to determine if the driver's seat is unoccupied; and
programming in said memory that when executed by said processor causes said processor to energize said actuator to operate said hydraulic assembly to move said adjustment arms to said deployed configuration when said load cell senses that the driver's seat is not occupied.

6. The wheel chock system as in claim 4, further comprising:
a load sensor in communication with the driver's seat and with said processor, said load sensor configured to determine if the driver's seat is unoccupied; and
programming in said memory that when executed by said processor causes said processor to energize said actuator to operate said hydraulic assembly to move said adjustment arms to said deployed configuration when said load cell senses that the driver's seat is not occupied.

7. The wheel chock system as in claim 3, further comprising:
a load sensor in communication with the driver's seat and with said processor, said load sensor configured to determine if the driver's seat is unoccupied; and
programming in said memory that when executed by said processor causes said processor to energize said actuator to operate said hydraulic assembly to move said adjustment arms to said deployed configuration when said load cell senses that the driver's seat is not occupied.

8. The wheel chock system as in claim 3, further comprising:
a gear sensor electrically connected to the vehicle transmission and to said processor, said gear sensor configured to determine when the vehicle transmission is in a parked configuration; and
programming in said memory that when executed by said processor causes said processor to energize said actuator to operate said hydraulic assembly to move said adjustment arms to said deployed configuration when said gear sensor determines that the vehicle transmission is in a parked configuration.

9. The wheel chock system as in claim 2, further comprising:
an ignition sensor electrically connected to the vehicle ignition switch and to said processor, said ignition sensor detecting when the ignition switch is at an off configuration;
programming in said memory that when executed by said processor causes said processor to energize said actuator to operate said hydraulic assembly to move said adjustment arms to said deployed configuration when the ignition switch is at the off configuration;
a gear sensor electrically connected to the vehicle transmission and to said processor, said gear sensor configured to determine when the vehicle transmission is in a parked configuration;
programming in said memory that when executed by said processor causes said processor to energize said actuator to operate said hydraulic assembly to move said adjustment arms to said deployed configuration when said gear sensor determines that the vehicle transmission is in a parked configuration;
a load sensor in communication with the driver's seat and with said processor, said load sensor configured to determine if the driver's seat is unoccupied; and
programming in said memory that when executed by said processor causes said processor to energize said actuator to operate said hydraulic assembly to move said adjustment arms to said deployed configuration when said load cell senses that the driver's seat is not occupied.

10. The wheel chock system as in claim 1, wherein each wheel chock includes a generally triangular configuration.

11. The wheel chock system as in claim 10, wherein each wheel chock is rotatably coupled to a respective second end of said adjustment arms such that said each wheel chock is selectively situated to position a selected side to bear against a respective tire at said deployed configuration.

12. The wheel chock system as in claim 9, wherein:
each wheel chock includes a generally triangular configuration; and
each wheel chock is rotatably coupled to a respective second of said adjustment arms such that said each wheel chock is selectively positioned to position a selected side to bear against a respective tire at said deployed configuration.

13. The wheel chock system as in claim 1, wherein said hydraulic assembly includes:
a reservoir configured to contain hydraulic fluid;
a ram housing coupled to each respective leaf spring of the vehicle, said ram housing being configured to receive respective first ends of said adjustment arms; and
a pump in fluid communication with said reservoir and said ram housing and configured to transmit said hydraulic fluid from said reservoir to said ram housing under pressure when actuated by said actuator so as to move said adjustment arms between said deployed and released configurations.

14. The wheel chock system as in claim 13, further comprising an auxiliary spring coupling said ram housing to the vehicle leaf spring.
